(19) United States
(12) Patent Application Publication
(10) Pub. No.: US 2026/0256648 A1
(43) Pub. Date: Sep. 3, 2026

(54) ROTARY TELESCOPIC MASSAGER

(71) Applicant: Dongguan Mengma Electronic Technology Co., Ltd., Dongguan City (CN)

(72) Inventor: Dongtao Zhou, Dongguan City (CN)

(21) Appl. No.: 19/557,055

(22) Filed: Mar. 4, 2026

(30) Foreign Application Priority Data
Jan. 27, 2026 (CN) 202610111349.5

(51) Int. Cl. A61H 23/02

(52) U.S. Cl. CPC A61H 23/0263; A61H 2023/0272; A61H 2201/0157; A61H 2209/00

(57) ABSTRACT

A rotary telescopic massager. A cylindrical shell includes a first cylindrical housing and a second cylindrical housing. A port of the first cylindrical housing is detachably joined to a port of the second cylindrical housing. A rotary telescopic apparatus is installed in an inner chamber of the first cylindrical housing and configured to drive a massage element to perform a rotary telescopic movement for performing massage. The massage element is disposed in an inner chamber of the second cylindrical housing and detachably connected to a rotary portion of a rotary driver.

### TECHNICAL FIELD

The present disclosure relates to the technical field of therapeutic massage, particularly to a rotary telescopic massager.

### BACKGROUND

A massager is an instrument designed to perform therapeutic massage on parts of a human body. Typically, a variety of automatic massagers have been developed to promote blood circulation for post-surgical rehabilitation, such as hand injuries. For example, a rotary massager formed by combining structures such as a motor and a flexible massage sleeve disposed within a cylindrical housing. However, a non-separatable nature of the cylindrical housing of such a massager poses difficulties in both disassembling the flexible massage sleeve for cleaning and reassembling it afterwards. Therefore, there is an urgent need for a massager solving the above-mentioned technical problems.

### SUMMARY

An objective of the present disclosure is to design a rotary telescopic massager to solve shortcomings of the prior art.

The rotary telescopic massager designed in the present disclosure includes:
a cylindrical shell including a first cylindrical housing and a second cylindrical housing, wherein a port of the first cylindrical housing is detachably joined to a port of the second cylindrical housing, a rotary telescopic apparatus is installed in an inner chamber of the first cylindrical housing and includes a first installation bracket, a first motor, a rotary driver, a guide rod, a connection rod and a rotary disk, wherein a guide channel disposed in an axial direction of the cylindrical shell is formed on the first installation bracket, the rotary driver is at least partially movably disposed within the guide channel, the rotary disk is installed on a rotary shaft of the first motor, an axis of the guide rod is parallel to an axis of the rotary driver, the rotary driver is slidably connected to the guide rod, and two ends of the connection rod are rotatably connected to an outer side of the rotary driver and an eccentric portion of the rotary disk, respectively; and
a massage element disposed in an inner chamber of the second cylindrical housing and including a cylindrical body and a flexible massage sleeve disposed within the cylindrical body, wherein a closed end of the cylindrical body is detachably connected to a rotary portion of the rotary driver, and an opening of the flexible massage sleeve is oriented in the same direction as an opening of the second cylindrical housing,
wherein when the first cylindrical housing is detached from the second cylindrical housing, the massage element is fully exposed, such that the massage element is disconnected from a rotary output shaft of the rotary driver, thereby rendering both the massage element and the first cylindrical housing with the rotary telescopic apparatus independent of each other.

According to the rotary telescopic massager described above, the rotary driver includes a movable element and a second motor, wherein the second motor is embedded and fixed within an installation chamber of the movable element, a rotary shaft of the second motor is in transmission connection with a gear set, the rotary output shaft is disposed on the gear set and detachably connected to the closed end of the cylindrical body after extending from one end of the movable element facing the massage element, and an end portion of the connection rod is rotatably connected to an outer side of the movable element.

According to the rotary telescopic massager described above, a guide sleeve is disposed on an outer wall of the movable element, the guide rod is fixed on an inner wall of the first installation bracket or the first cylindrical housing, and the guide sleeve is sleeved over the guide rod.

According to the rotary telescopic massager described above, a first fixation hole is formed in the first installation bracket, a first fixation sleeve is sleeved and fixed over one end of the guide rod, the first fixation sleeve is inserted into the first fixation hole, and the first fixation hole and the first fixation sleeve are fixed in an interference fit manner.

According to the rotary telescopic massager described above, a first connection sleeve is fixed on the rotary output shaft, a second connection sleeve is disposed on the closed end of the cylindrical body, the first connection sleeve and the second connection sleeve are sleeved and fitted onto each other, and the first connection sleeve is connected to the second connection sleeve by a snap fastener.

According to the rotary telescopic massager described above, the rotary telescopic apparatus further includes a second installation bracket, wherein the second installation bracket is fixedly connected to the inner wall of the first cylindrical housing, the first motor is fixed on the second installation bracket, a second fixation hole is formed in the second installation bracket, a second fixation sleeve is sleeved and fixed over the other end of the guide rod, the second fixation sleeve is inserted into the second fixation hole, and the second fixation hole and the second fixation sleeve are fixed in an interference fit manner.

According to the rotary telescopic massager described above, a connection shaft is fixed on the rotary output shaft, a first connector is fixed on the connection shaft, a support element is disposed between the first connector and a port of the guide channel, the connection shaft passes through a through hole of the support element, the support element is fixedly arranged in a radial direction, two first conductors are disposed on a first side on the first connector facing the support element, two second conductors are disposed on a third side on the support element facing the first connector, and each of the first conductors is in conductive contact with the two second conductors, respectively; the two first conductors are annular conductors arranged around the connection shaft, and the two second conductors are conductive pins or conductive springs; alternatively, the two first conductors are conductive pins or conductive springs, and the two second conductors are annular conductors arranged around the connection shaft; and
a second connector is disposed on the closed end of the cylindrical body, the first connector is connected to the second connector by a snap fastener, two third conductors are disposed on a second side on the first connector facing the second connector, two fourth conductors are disposed on a fourth side on the second connector facing the first connector, and each of the third conductors is in conductive contact with the two fourth conductors, respectively; the two third conductors are annular conductors arranged around the connection shaft, and the two fourth conductors are conductive pins or conductive springs; alternatively, the two third conductors are conductive pins or conductive springs, and the two fourth conductors are annular conductors arranged around the connection shaft,
wherein each of the first conductors is conductively connected to the two third conductors, respectively, a functional massage element is installed on the flexible massage sleeve, the two fourth conductors are conductively connected to the functional massage element via conductive connection wires after passing through the closed end of the cylindrical body, and the functional massage element is a first vibrator or an electric heating sheet.

According to the rotary telescopic massager described above, the first connector includes a first connection sleeve and a first annular plate, wherein the first annular plate is fixed within the first connection sleeve, the first side and the second side are disposed on the first annular plate, the two first conductors are disposed on the first side on the first annular plate facing the support element, and the two third conductors are disposed on the second side on the first connection sleeve facing the massage element;
the second connector includes a second connection sleeve and a second annular plate, wherein the first connection sleeve and the second connection sleeve are sleeved and fitted onto each other, the first connection sleeve is connected to the second connection sleeve by a snap fastener, the fourth side is disposed on the second annular plate, the second annular plate is fixed within the second connection sleeve, and the two fourth conductors are disposed on the fourth side on the second annular plate facing the first connector; and
the support element includes an annular support plate and a third annular plate, wherein the third side is disposed on the third annular plate, the third annular plate is fixed on the fifth side on the annular support plate facing the second annular plate, and the two second conductors are disposed on the third side on the third annular plate facing the second annular plate,
wherein the first connection sleeve, the first annular plate, the second connection sleeve, the second annular plate, the annular support plate and the third annular plate are coaxially arranged, and the connection shaft is fixedly connected to the first connection sleeve after passing through the annular support plate and the third annular plate in sequence; at least one guide rod is disposed on the annular support plate and inserted into a guide hole of the installation bracket to fix the support element in a radial direction; and a power supply apparatus is installed within the first cylindrical housing and conductively connected to the two second conductors via conductive connection wires.

According to the rotary telescopic massager described above, a flexible sleeve is installed at an opening of the second cylindrical housing, a passageway is formed on the flexible sleeve and coaxially arranged with a massage chamber of the flexible massage sleeve, and a plurality of flexible massage protrusions are formed on an inner wall of the massage chamber of the flexible massage sleeve.

According to the rotary telescopic massager described above, a second vibrator is embedded and installed in the flexible sleeve, the second vibrator is close to an inner wall of the passageway, and the power supply apparatus is installed within the first cylindrical housing and conductively connected to the second vibrator via a conductive connection wire after passing through the installation bracket.

According to the rotary telescopic massager described above, a connection cylinder is formed on the first installation bracket, the first cylindrical housing is sleeved on a first half portion of the connection cylinder, the second cylindrical housing is sealed and sleeved over a second half portion of the connection cylinder by a seal ring, a plurality of L-shaped slots and a plurality of tabs are respectively disposed on an outer wall of the connection cylinder and an inner wall of a port of the second cylindrical housing facing the connection cylinder, and the tabs are engaged in horizontal slots of the L-shaped slots through longitudinal slots of the L-shaped slots.

According to the rotary telescopic massager described above, a suction pump and an electromagnetic valve are disposed within the first cylindrical housing, the inner chamber of the connection cylinder and the inner chamber of the second cylindrical housing are joined to form a negative pressure massage chamber, a pressure relief port and a suction port are provided in a divider plate of the first installation bracket, an intake port of the second suction pump is connected to the suction port through a pipeline, an inlet port of the electromagnetic valve is coupled to the pressure relief port through a pipeline, and an outlet port of the electromagnetic valve and an exhaust port of the second suction pump are respectively coupled to two outlet holes on the first cylindrical housing through pipelines.

The rotary telescopic massager designed by the present disclosure has the following beneficial effects.
1. The present disclosure utilizes a design that the first cylindrical housing can be separated from the second cylindrical housing and the cylindrical body with the flexible massage sleeve may be detached from the rotary driver, allowing for convenient cleaning of the flexible massage sleeve and easy reassembly afterwards.
2. The present disclosure is capable of providing rotary telescopic massage, vibration massage and negative pressure massage during massage, thereby offering diversified massage functions and enhanced massage effectiveness. Furthermore, a push-pull structure is adopted during telescopic drive, making a structure simple and easy to manufacture.

### BRIEF DESCRIPTION OF THE DRAWINGS

FIG. 1 is a schematic diagram (I) showing an overall structure of a massager.

FIG. 2 is an exploded view of a massager.

FIG. 3 is a cross-sectional view (I) of a massager.

FIG. 4 is an enlarged view of a region A.

FIG. 5 is a cross-sectional view (I) of a first cylindrical housing with a rotary telescopic apparatus.

FIG. 6 is a schematic structural diagram (I) of a local assembly structure.

FIG. 7 is a schematic structural diagram (II) of a local assembly structure.

FIG. 8 is an exploded view (I).

FIG. 9 is an exploded view (II).

FIG. 10 is a schematic diagram (II) showing an overall structure of a massager.

FIG. 11 is an exploded view (I) of a massager with a first cylindrical housing with a rotary telescopic apparatus, a second cylindrical housing and a massage element shown in their respective independent states.

FIG. 12 is an exploded view (II) of a massager with a first cylindrical housing with a rotary telescopic apparatus, a second cylindrical housing and a massage element shown in their respective independent states.

FIG. 13 is a cross-sectional view (II) of a massager.

FIG. 14 is an enlarged view of a region B.

FIG. 15 is a cross-sectional view (III) of a massager.

FIG. 16 is an enlarged view of a region C.

FIG. 17 is a cross-sectional view (II) of a first cylindrical housing with a rotary telescopic apparatus.

FIG. 18 is an exploded view (III).

FIG. 19 is an exploded view (IV).

FIG. 20 is a schematic structural diagram of a first cylindrical housing with a rotary telescopic apparatus.

FIG. 21 is a schematic diagram showing a planar structure of a fourth conductor.

FIG. 22 is a schematic diagram showing a planar structure of a second conductor.

FIG. 23 is an exploded view (III) of a massager with a first cylindrical housing with a rotary telescopic apparatus, a second cylindrical housing and a massage element shown in their respective independent states.

FIG. 24 is an exploded view (IV) of a massager with a first cylindrical housing with a rotary telescopic apparatus, a second cylindrical housing and a massage element shown in their respective independent states.

FIG. 25 is a schematic diagram showing a local structure of a massager.

FIG. 26 is a schematic diagram (III) showing an overall structure of a massager.

FIG. 27 is an exploded view (V).

Reference numerals: 1, cylindrical shell; 11, first cylindrical housing; 12, second cylindrical housing; 13, outer cylindrical housing; 14, negative pressure massage chamber; 15, suction pump; 16, electromagnetic valve; 17, battery; 18, pipeline; 19, three-way joint; 121, L-shaped slot; 122, flange; 151, intake port; 152, exhaust port; 191, inlet port; 192, outlet port; 2, rotary telescopic apparatus; 21, first installation bracket; 22, second installation bracket; 23, first motor; 24, rotary driver; 25, rotary disk; 26, connection rod; 27, connection shaft; 28, first connection sleeve; 210, connection cylinder; 211, first half portion; 212, second half portion; 213, guide channel; 214, guide hole; 215, suction port; 216, first fixation hole; 217, first fixation sleeve; 218, second fixation hole; 219, second fixation sleeve; 220, tab; 21, divider plate; 222, pressure relief port; 241, movable element; 242, installation chamber; 243, second motor; 244, shaft portion; 245, gear set; 246, rotary output shaft; 247, guide rod; 2411, guide sleeve; 251, eccentric shaft; 261, hinge hole; 281, polygonal insertion hole; 282, notch; 283, flexure; 284, detent; 285, limit recess; 3, control circuit board; 31, power button; 32, functional control button; 4, massage element; 41, cylindrical body; 42, flexible massage sleeve; 411, pressure circulation port; 412, second connection sleeve; 4121, catch slot; 4122, limit boss; 421, massage chamber; 422, flexible massage protrusion; 5, flexible sleeve; 51, passageway; 52, embedded slot; 53, second vibrator; 54, annular slot; 6, charging interface; 7, seal ring; 8, first connector; 81, first annular plate; 82, first conductor; 83, third conductor; 84, conductive connection post; 9, second connector; 91, second annular plate; 92, fourth conductor; 10, support element; 101, third annular plate; 102, annular support plate; 103, guide rod; 104, second conductor; and 105, through hole.

### DESCRIPTION OF THE EMBODIMENTS

Embodiments of the present disclosure will be further described in further details below in conjunction with accompanying drawings.

Embodiment 1

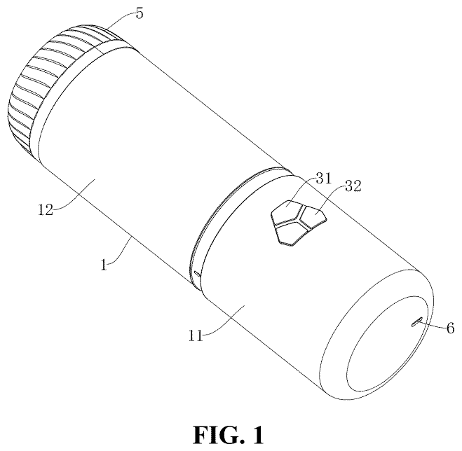

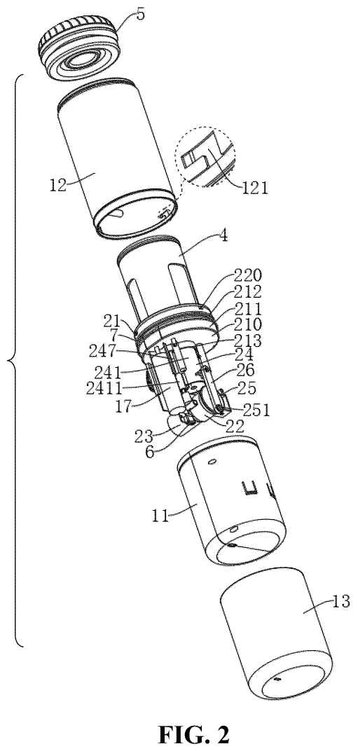

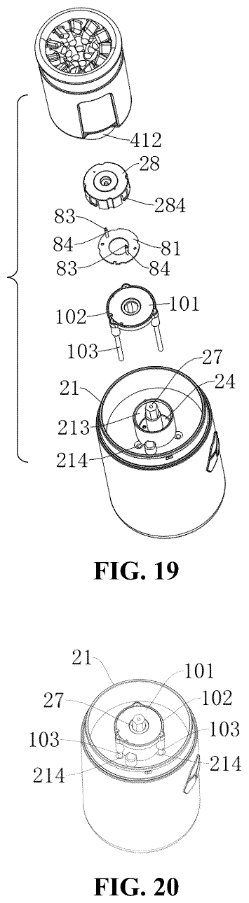

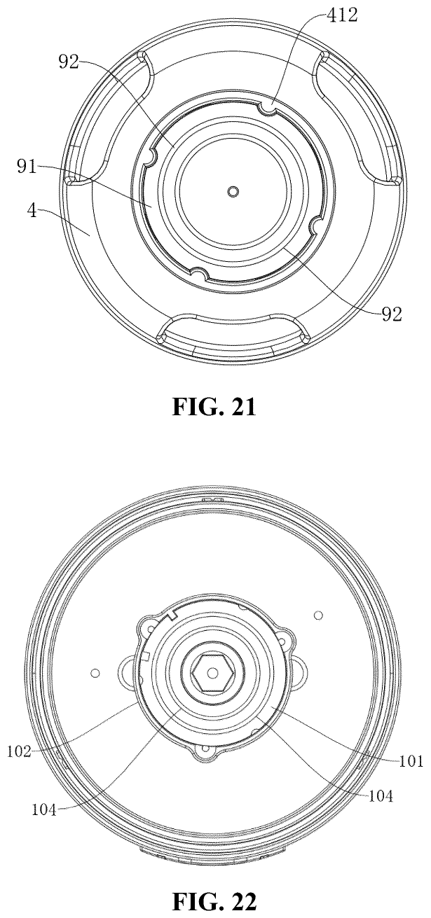

As shown in FIG. 1 to FIG. 26, a rotary telescopic massager described in this embodiment includes a cylindrical shell 1, and a massage element 4 and a rotary telescopic apparatus 2 which are disposed within the cylindrical shell 1, such that the rotary telescopic apparatus 2 is used to drive the massage element 4 to rotate while driving the massage element 4 to reciprocate in a length direction of the cylindrical shell 1. The massager is suitable for massaging fingers or penis of an adult.

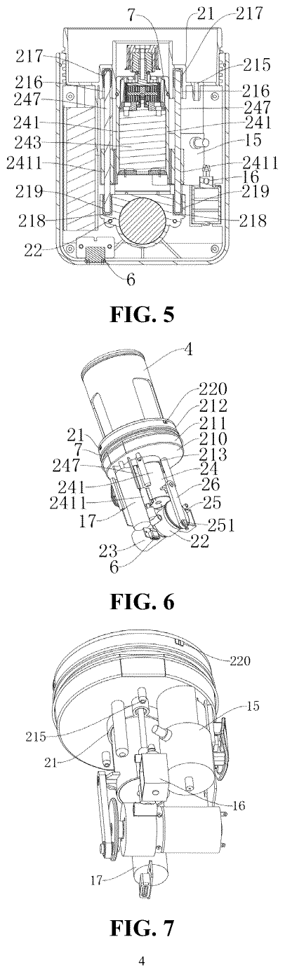

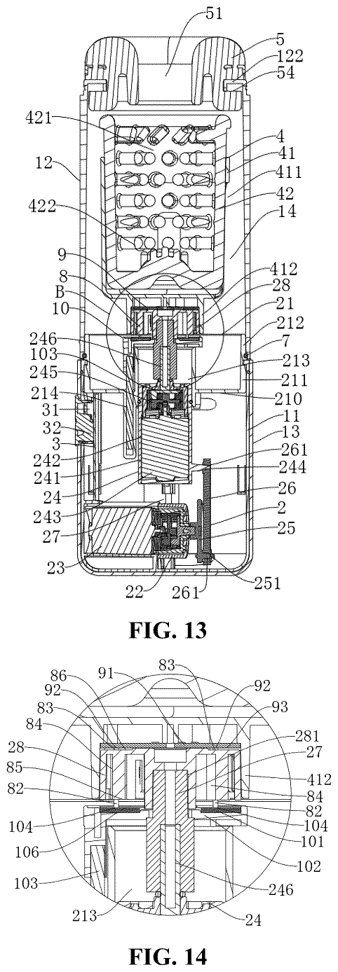

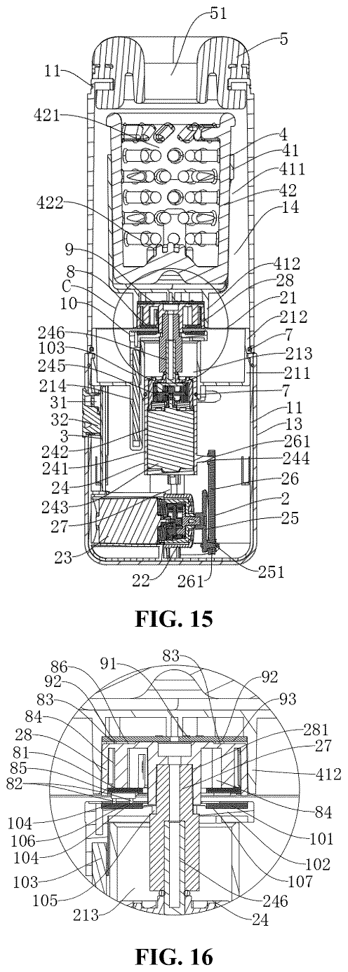

In this embodiment, as shown in FIG. 1 to FIG. 3, FIG. 6, FIG. 13 and FIG. 15, the cylindrical shell 1 includes a first cylindrical housing 11 and a second cylindrical housing 12. A port of the first cylindrical housing 11 is detachably joined to a port of the second cylindrical housing 12. A rotary telescopic apparatus 2 is installed in an inner chamber of the first cylindrical housing 11. The rotary telescopic apparatus 2 includes a first installation bracket 21, a first motor 23, a rotary driver 24, a guide rod 247, a connection rod 26 and a rotary disk 25. A guide channel 213 disposed in an axial direction of the cylindrical shell 1 is formed on the first installation bracket 21. The rotary driver 24 is at least partially movably disposed within the guide channel 213. The rotary disk 25 is installed on a rotary shaft of the first motor 23. An axis of the guide rod 247 is parallel to an axis of the rotary driver 24. The rotary driver 24 is slidably connected to the guide rod 247. The rotary driver 24 includes a movable element 241 and a second motor 243. The second motor 243 is embedded and fixed within an installation chamber 242 of the movable element 241. That is, the movable element 241 is of a sleeve structure. A port of the movable element 241 being of the sleeve structure is sealed with a cover plate for fixedly installing the second motor 243. A rotary shaft of the second motor 243 is in transmission connection with a gear set 245. The gear set 245 typically employs a planetary gear set. A rotary output shaft 246 is installed on the gear set 245. The rotary output shaft 246 is detachably connected to a closed end of the cylindrical body 41 after extending from one end of the movable element 241 facing the massage element 4. An end portion of the connection rod 26 is rotatably connected to an outer side of the movable element 241. That is, a shaft portion 244 is disposed on an outer side of an end portion of the movable element 241 close to the second motor 243 and hinged within a hinge hole 261 in one end of the connection rod. An eccentric shaft 251 is hinged within a hinge hole 261 in the other end of the connection rod, such that two ends of the connection rod 26 are rotatably connected to an outer side of the rotary driver 24 and an eccentric portion of the rotary disk 25, respectively. During operation, the first motor 23 is energized to drive the rotary disk 25 to rotate, causing the eccentric shaft 251 to orbit around the rotary shaft of the first motor 23, thereby pushing and pulling the movable element 241 and enabling the movable element 241 to reciprocate along its axis within the guide channel 213. Meanwhile, the second motor 243 is energized to drive the massage element 4 to rotate, thereby enabling the massage element 4 to perform rotary telescopic massage on the finger or penis of a human body.

The massage element 4 is disposed in the inner chamber of the second cylindrical housing 12. The massage element 4 includes a cylindrical body 41 and a flexible massage sleeve 42 disposed within the cylindrical body 41. The closed end of the cylindrical body 41 is detachably connected to a rotary portion of the rotary driver 24. An opening of the flexible massage sleeve 42 is orientated in the same direction as an opening of the second cylindrical housing 12. The flexible massage sleeve 42 is made of a flexible silicone material to provide a comfortable contact feel with the skin of a finger or penis of the human body. Moreover, a distance from a bottom of the massage chamber 421 of the flexible massage sleeve 42 to an opening end of the second cylindrical housing 12 is adapted to accommodate the length of the fingers or penis of a typical adult. Therefore, during the rotary telescopic massage, when a finger or penis is inserted into the massage chamber 421 of the flexible massage sleeve 42, and flexible massage protrusions 422 within the massage chamber 421 come into contact with the skin of the finger or penis. As a result, as the flexible massage sleeve 42 rotates and reciprocates, a massage action is performed on the finger or penis to promote blood circulation. An inner diameter of the massage chamber 421 is adaptively configured to match an outer diameter and a length dimension of the finger or penis of the adult.

Preferably, a seal ring 7 is sleeved and engaged over a portion on the movable element 241 located within the guide channel 213. An outer peripheral wall of the seal ring 7 is in contact with an inner wall of the guide channel 213, thereby providing a seal between the movable element 241 and the guide channel 213 to prevent moisture and the like from entering the inner chamber of the first cylindrical housing 11.

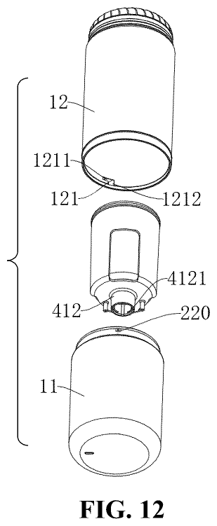

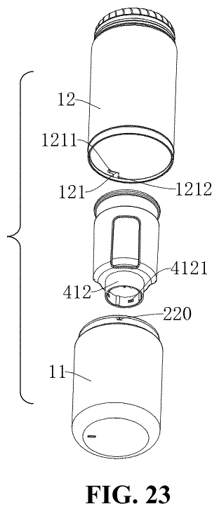

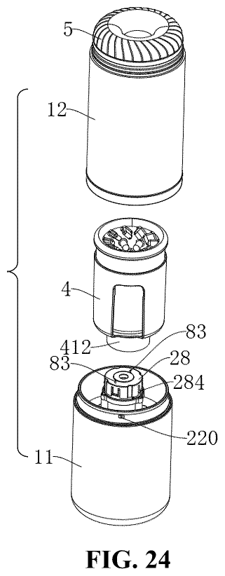

In this embodiment, as shown in FIG. 11, FIG. 12, FIG. 23 and FIG. 24, a connection cylinder 210 is integrally formed on the first installation bracket 21. The first cylindrical housing 11 is sleeved over a first half portion 211 of the connection cylinder 210, and the second cylindrical housing 12 is sealed and sleeved over a second half portion 212 of the connection cylinder 210 via the seal ring 7. Moreover, a plurality of L-shaped slots 121 arranged in an annular array and a plurality of tabs 220 arranged in an annular array are respectively disposed on an outer wall of the connection cylinder 210 and an inner wall of a port of the second cylindrical housing 12 facing the connection cylinder 210. The tabs 220 are engaged within horizontal slots 1212 of the L-shaped slots 121 through longitudinal slots 1211 of the L-shaped slots 1211, thereby achieving a detachable connection between the first cylindrical housing 11 and the connection cylinder 210. Such a structural arrangement allows for convenient disassembly and assembly.

In this embodiment, the detachable connection between the rotary output shaft 246 and the closed end of the cylindrical body 41 may be implemented in two structural configurations, as detailed below.

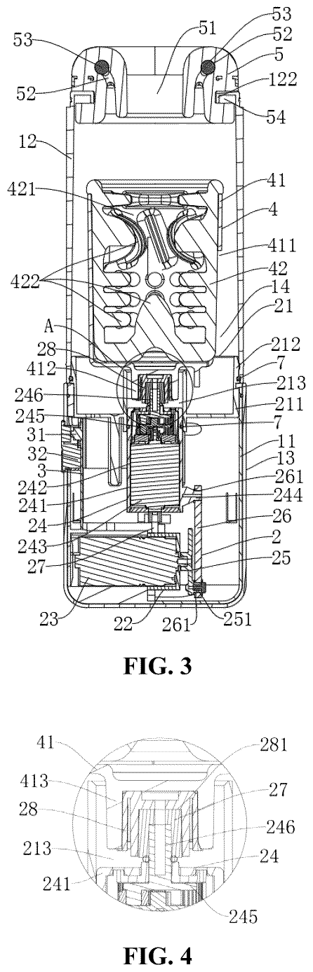

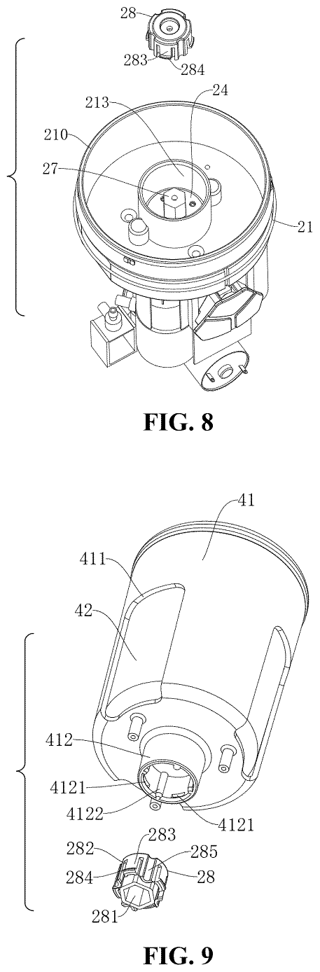

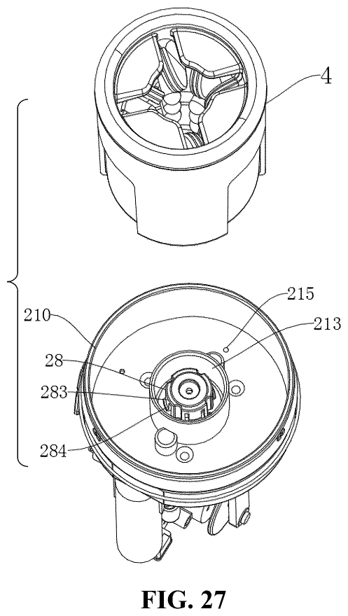

The first structural configuration is described as follows. As shown in FIG. 3, FIG. 4, FIG. 8 to FIG. 10 and FIG. 27, a first connection sleeve 28 is fixed on the rotary output shaft 246, that is, a connection shaft 27 is fixed on the rotary output shaft 246. An end portion of the connection shaft 27 is of a polygonal structure. A polygonal insertion hole 281 is provided in the first connection sleeve 28. The polygonal structure on the connection shaft 27 is inserted into the polygonal insertion hole 281 of the first connection sleeve 28. Then, the first connection sleeve 28 is fixedly connected to an end face of the connection shaft 27 by a bolt. A second connection sleeve 412 is disposed at the closed end of the cylindrical body 41. The first connection sleeve 28 and the second connection sleeve 412 are sleeved and fitted onto each other. Moreover, the first connection sleeve 28 is connected to the second connection sleeve 412 by a snap fastener. That is, a plurality of flexures 283 is formed on an outer peripheral wall of the first connection sleeve 28 in a way of providing a plurality of notches 282. A plurality of detent 284 arranged in an annular array are formed on the flexures 283. A plurality of catch slots 4142 arranged in an annular array are formed in an inner peripheral wall of the second connection sleeve 412. A snap-fit connection is achieved when the second connection sleeve 412 is sleeved over the first connection sleeve and the detents 284 are subsequently engaged within the catch slots 4121.

The second structural configuration is described as follows. As shown in FIG. 13 to FIG. 24, the connection shaft 27 is fixed on the rotary output shaft 246. A first connector 8 is fixed on the connection shaft 27. A support element 10 is disposed between the first connector 8 and the port of the guide channel 213. The connection shaft 27 passes through a through hole 105 of the support element 10. The support element 10 is fixedly disposed in a radial direction. Two first conductors 82 are disposed on a first side 85 on the first connector 8 facing the support element 10. Two second conductors 104 are disposed on a third side 106 on the support element 10 facing the first connector 8. Moreover, each of the first conductors 82 is in conductive contact with the two second conductors 104, respectively. The two first conductors 82 are annular conductors arranged around the connection shaft, and the two second conductors 104 are conductive pins or conductive springs. Alternatively, the two first conductors 82 are conductive pins or conductive springs, and the two second conductors 104 are annular conductors arranged around the connection shaft. A second connector 9 is disposed on the closed end of the cylindrical body 41. The first connector 8 is connected to and the second connector 9 by a snap fastener. Further, two third conductors 83 are disposed on a second side 86 on the first connector 8 facing the second connector 9. Two fourth conductors 92 are disposed on a fourth side 93 on the second connector 9 facing the first connector 8. Further, each of the third conductors 83 is in conductive contact with the two fourth conductors 92, respectively. The two third conductors 83 are annular conductors arranged around the connection shaft, and the two fourth conductors 92 are conductive pins or conductive springs. Alternatively, the two third conductors 83 are conductive pins or conductive springs, and the two fourth conductors 92 are annular conductors arranged around the connection shaft 27. Moreover, each of the first conductors 82 is conductively connected to the two third conductors 83, respectively. A functional massage element is installed on the flexible massage sleeve 42. The two fourth conductors 92 are conductively connected to the functional massage element via conductive connection wires after passing through the closed end of the cylindrical body 41. The functional massage element is either a first vibrator or an electric heating sheet. The first vibrator employs a vibration motor, and the electric heating sheet employs a graphene heating sheet or a copper wire heating sheet. Such a structural configuration enables the first vibrator or electric heating sheet to maintain a normal electrical operation during the rotation of the massage element, while preventing the conductive connection wires from being tangled. In this way, throughout the rotation of the massage element 4, the two first conductors 82 remain in continuous contact with the two second conductors 104 during the rotation, respectively. Moreover, the first connector 8 and the second connector 9 are fixedly installed, such that the third conductors 83 remain in continuous contact with the fourth conductors 92, thereby achieving a stable power supply to the first vibrator or electric heating sheet.

More preferably, the first connector 8 includes a first connection sleeve 28 and a first annular plate 81. The first annular plate 81 is fixed within the first connection sleeve 28. The first side 85 and the second side 86 are disposed on the first annular plate 81. The two first conductors 82 are disposed on the first side 85 on the first annular plate 81 facing the support element 10. The two third conductors 83 are disposed on the second side 86 on the first connection sleeve facing the massage element 4. The second connector 9 includes a second connection sleeve 412 and a second annular plate 91. The first connection sleeve 28 and the second connection sleeve 412 are sleeved and fitted onto each other. Moreover, the first connection sleeve 28 is connected to the second connection sleeve 412 by a snap fastener. That, a plurality of flexures 283 are formed on an outer peripheral wall of the first connection sleeve 28 in a way of providing a plurality of notches 282. A plurality of detents 284 arranged in an annular array are formed on the flexures 283. A plurality of catch slots 4142 arranged in an annular array are formed in an inner peripheral wall of the second connection sleeve 412. A snap-fit connection is achieved when the second connection sleeve 412 is sleeved over the first connection sleeve and the detents 284 are subsequently engaged within the catch slots 4121. The fourth side 93 is disposed on the second annular plate 91. The second annular plate 91 is fixed within the second connection sleeve 412. The two fourth conductors 92 are disposed on the fourth side 93 on the second annular plate 91 facing the first connector 8. The support element 10 includes an annular support plate 102 and a third annular plate 101. The third side 106 is disposed on the third annular plate 101. The third annular plate 101 is fixed on the fifth side 107 on the annular support plate 102 facing the second annular plate 91. The two second conductors 104 are disposed on the third side 106 on the third annular plate 101 facing the second annular plate 91. Among them, the first connection sleeve 28, the first annular plate 81, the second connection sleeve 412, the second annular plate 91, the annular support plate 102 and the third annular plate 101 are coaxially arranged. Moreover, the connection shaft 27 is fixedly connected to the first connection sleeve 28 after passing through the annular support plate 102 and the third annular plate 101 in sequence. That is, the end portion of the connection shaft 27 is of the polygonal structure. The polygonal insertion hole 281 is provided in the first connection sleeve. The polygonal structure on the connection shaft 27 is inserted into the polygonal insertion hole 281 of the first connection sleeve 28. Then, the first connection sleeve 28 is fixedly connected to an end face of the connection shaft by a bolt. At least one guide rod 103 is disposed on the annular support plate 102. The guide rod 103 is inserted into the guide hole 214 of the installation bracket to fix the support element 10 in the radial direction. A power supply apparatus is conductively connected to the two second conductors 104 via conductive connection wires, respectively. The power supply apparatus employs a battery 17.

In order to ensure reliable conductive connection, each of the first conductors 82 is conductively connected to the two third conductors 83 through conductive connection posts 84, respectively.

Preferably, the first annular plate 81, the second annular plate 91 and the third annular plate 101 all employ circuit boards. The two annular conductors typically employ annular copper sheets which have different outer diameters but are coaxially arranged.

Therefore, when the first cylindrical housing 11 is detached from the second cylindrical housing 12, the first cylindrical housing 11 axially rotates relative to the second cylindrical housing 12 to displace the tabs 220 on the first cylindrical housing 11 to into the longitudinal slots 1212 of the L-shaped slots 121, and then, the first cylindrical housing 11 moves axially relative to the second cylindrical housing 12 disengage the tabs from the longitudinal slots 1212 of the L-shaped slots 121, thereby realizing detachment and separation of the first cylindrical housing 11 from the second cylindrical housing 12. After the cylindrical housing 11 is detached from the second cylindrical housing 12, the massage element 4 is fully exposed, such that the massage element 4 is disconnected from the rotary output shaft 246 of the rotary driver 24. The presence of inclined surfaces on the detents 284 in a connection contact direction enables the disconnection by mere axial outward movement of the cylindrical body 41, which guides the detents 284 out of the catch slots 4121 by the inclined surfaces, thereby achieving connection contact and rendering both the massage element 4 and the first cylindrical housing 11 with the rotary telescopic apparatus 2 independent of each other.

Further, the connection cylinder 210, the first cylindrical housing 11 and the second cylindrical housing 12 are all configured in a cylindrical form. Limit recesses 285 are formed on an outer wall of the first connection sleeve 28. Limit bosses 4122 are formed on an inner wall of the second connection sleeve 412. The limit bosses 4122 are fitted within the limit recesses 285, thereby providing mutual radial constraint between the first connection sleeve 28 and the second connection sleeve 412. Further, both the limit bosses 4122 and the limit recesses 285 are of an axially elongated structure.

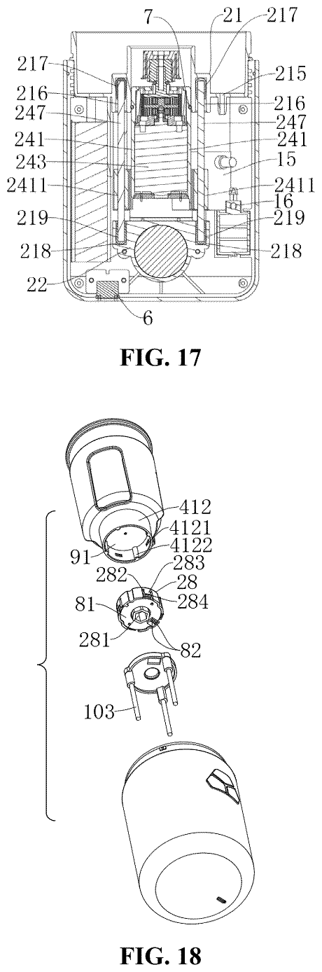

In this embodiment, as shown in FIG. 5 and FIG. 17, the guide sleeve 2411 is disposed on the outer wall of the movable element 241. The guide rod 247 is fixed on the inner wall of the first installation bracket 21 or the first cylindrical housing 11. The guide sleeve 2411 is sleeved over the guide rod 247. The first fixation hole 216 is formed in the first installation bracket 21. The first fixation sleeve 217 is sleeved and fixed on one end of the guide rod 247. The first fixation sleeve 217 is inserted into the first fixation hole 216. Further, the first fixation hole 216 and the first fixation sleeve 217 are fixed in an interference fit manner. The guide rod 247 is generally made of metal, which provides better support for the rotary driver 24 and improves the structural stability. Furthermore, two guide rods 247 are provided and are symmetrically arranged, and two guide sleeves 2411 and two first fixation holes 216 are provided and are symmetrically arranged, which results in greater stability when the rotary driver reciprocates and a more compact and reliable structure.

Preferably, the rotary telescopic apparatus 2 further includes a second installation bracket 22, wherein the second installation bracket 22 is fixedly connected to the inner wall of the first cylindrical housing 11, the first motor 23 is fixed on the second installation bracket 22, a second fixation hole 218 is formed in the second installation bracket 22, a second fixation sleeve 219 is sleeved and fixed on the other end of the guide rod 247, the second fixation sleeve 219 is inserted into the second fixation hole 218, and the second fixation hole 218 and the second fixation sleeve 219 are fixed in an interference fit manner. Such a structural configuration enables the guide rod 247 to be fixed more stably. Further, two second fixation holes are provided and are symmetrically arranged.

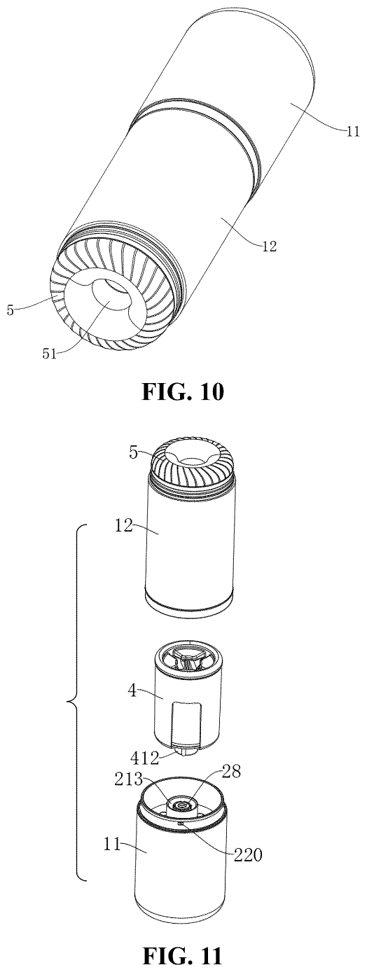

In this embodiment, as shown in FIG. 1 to FIG. 3, FIG. 10, FIG. 13 and FIG. 15, a flexible sleeve 5 is installed at an opening of the second cylindrical housing 12. A passageway 51 is formed on the flexible sleeve 5 and coaxially arranged with the massage chamber 421 of the flexible massage sleeve 42. A plurality of flexible massage protrusions 422 are formed on the inner wall of the massage chamber 421 of the flexible massage sleeve 42. The flexible sleeve 5 is made of a flexible silicone material to provide a comfortable contact feel when being configured to support the base of the finger or penis. The flexible massage protrusions 422 allow for tighter contact with the skin of the finger or penis. Among them, the opening of the second cylindrical housing 12 and the outer wall of the flexible sleeve 5 are fit and arranged in a concave-convex configuration. That is, a flange 122 and an annular slot 54 are formed on the inner wall of the opening of the second cylindrical housing 12 and the outer peripheral wall of the flexible sleeve 5, respectively, and the flange 122 is embedded within the annular slot 54 to fixedly install the flexible sleeve 5.

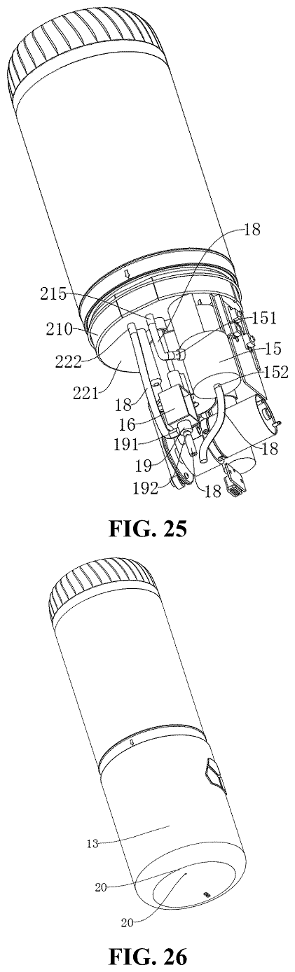

In this embodiment, as shown in FIG. 7, FIG. 25 and FIG. 26, a suction pump 15 and an electromagnetic valve 16 are disposed within the first cylindrical housing 11. The inner chamber of the connection cylinder 210 and the inner chamber of the second cylindrical housing 12 are joined to form a negative pressure massage chamber 14. A pressure relief port 222 and a suction port 215 are provided in the divider plate 221 of the first installation bracket 21. The intake port 151 of the second suction pump 15 is coupled to the suction port 215 via a pipeline 18. An inlet port 191 of the electromagnetic valve 16 is coupled to the pressure relief port 222 via the pipeline 18. An outlet port 192 of the electromagnetic valve 16 and the exhaust port 152 of the second suction pump 15 are respectively coupled to two outlet holes 20 in the first cylindrical housing 11 via the pipeline 18. When the finger or penis is placed within the negative pressure massage chamber 14 after passing through the flexible sleeve 5, the inner wall of the flexible sleeve 5 is fitted tightly against the skin of the base of the finger or penis to enable the negative pressure massage chamber to be sealed. At this point, the electromagnetic valve 16 is in an off state. Then, the suction pump 15 operates to suck air to continuously evacuating air within the negative pressure massage chamber 14, such that the negative pressure massage chamber 14 is in a negative pressure state. In this way, air pressure is applied to the flexible massage sleeve 42 through an air pressure circulation port 411 in the cylindrical body 41, enabling the flexible massage protrusions 422 on the inner wall of the flexible massage sleeve 42 to squeeze the finger or penis, thereby achieving negative pressure massage. After air is evacuated for a period of time, the suction pump 15 stops operating. The electromagnetic valve 16 is then in an open state, allowing air to enter the negative pressure massage chamber 14 through a circulation channel within the electromagnetic valve. The flexible massage sleeve 42 releases, thereby ceasing pressure on the finger or penis. Finally, such a negative pressure massage procedure may be repeated multiple times on the finger or penis. An inner hole of the flexible sleeve 5 is dimensioned to accommodate the finger or penis of the adult.

Preferably, a first port of the three-way joint 19 is connected to a port of the circulation channel of the electromagnetic valve 16, a second port of the three-way joint 19 serves as the inlet port 191, and a third port of the three-way joint 19 serves as the outlet port 192.

More preferably, the first cylindrical housing 11, the second cylindrical housing 12, the first installation bracket 21, the second installation bracket 22, the first connection sleeve, the second connection sleeve 412, the movable element 241 and the cylindrical body 41 are all made of plastic, thereby reducing the overall weight of the massager.

In this embodiment, as shown in FIG. 1, FIG. 3, FIG. 6, FIG. 13 and FIG. 15, a control circuit board 3 is disposed in the inner chamber of the first cylindrical housing 11. An MCU control chip, a power button 31, a functional control button 32 and a power supply apparatus are disposed on the control circuit board 3. The power button 31, the functional control button 32 and the power supply apparatus are respectively connected to and controlled by the MCU control chip. The power supply apparatus supplies power to the first motor 23, the second motor 243, the suction pump 15 and the electromagnetic valve 16, and is controlled by the power button 31, the functional control button 32 and the MCU control chip. The power supply apparatus employs the battery 17. Electrically connected to the battery 17 is a charging interface 6. The charging interface 6 extends through both the first cylindrical housing 11 and the outer cylindrical housing 13. The charging interface 6 typically adopts a TYPE-C interface or a USB interface.

In this embodiment, as shown in FIG. 26, the outer cylindrical housing 13 made of plastic is sleeved and fixed on the outer wall of the first cylindrical housing 11 to protect the first cylindrical housing 11. Further, both the power button 31 and the functional control button 32 extend through the first cylindrical housing 11 and the outer cylindrical housing 13. Two holes in the outer cylindrical housing 13 are communicated with the individual outlet holes 20, respectively.

In another embodiment, as shown in FIG. 3, a second vibrator 53 is embedded and tightly fitted within an embedded slot 52 of the flexible sleeve 5. The second vibrator 53 is close to an inner wall of the passageway 51. The power supply apparatus is conductively connected to the second vibrator 53 via a conductive connection wire after passing through the first installation bracket. The power supply apparatus adopts the battery 17. Such a structural configuration offers diversified massage functions and enhanced massage effectiveness. The second vibrator 53 adopts a vibration motor. The embedded slot 52 is communicated with the inner chamber of the second cylindrical housing 12 via a wire channel, facilitating the installation of the second vibrator 53. This embodiment is primarily applicable to the rotary telescopic massager with the first structural configuration described above. However, this embodiment can also be applied to the rotary telescopic massager with the second structural configuration described above as needed.

What is claimed is:

1. A rotary telescopic massager, comprising:
a cylindrical shell comprising a first cylindrical housing and a second cylindrical housing, wherein a port of the first cylindrical housing is detachably joined to a port of the second cylindrical housing, a rotary telescopic apparatus is installed in an inner chamber of the first cylindrical housing and comprises a first installation bracket, a first motor, a rotary driver, a guide rod, a connection rod and a rotary disk, wherein a guide channel disposed in an axial direction of the cylindrical shell is formed on the first installation bracket, the rotary driver is at least partially movably disposed within the guide channel, the rotary disk is installed on a rotary shaft of the first motor, an axis of the guide rod is parallel to an axis of the rotary driver, the rotary driver is slidably connected to the guide rod, and two ends of the connection rod are rotatably connected to an outer side of the rotary driver and an eccentric portion of the rotary disk, respectively; and
a massage element disposed in an inner chamber of the second cylindrical housing and comprising a cylindrical body and a flexible massage sleeve disposed within the cylindrical body, wherein a closed end of the cylindrical body is detachably connected to a rotary portion of the rotary driver, and an opening of the flexible massage sleeve is oriented in the same direction as an opening of the second cylindrical housing,
wherein when the first cylindrical housing is detached from the second cylindrical housing, the massage element is fully exposed, such that the massage element is disconnected from a rotary output shaft of the rotary driver, thereby rendering both the massage element and the first cylindrical housing with the rotary telescopic apparatus independent of each other.

2. The rotary telescopic massager according to claim 1, wherein the rotary driver comprises a movable element and a second motor, wherein the second motor is embedded and fixed within an installation chamber of the movable element, a rotary shaft of the second motor is in transmission connection with a gear set, the rotary output shaft is disposed on the gear set and detachably connected to the closed end of the cylindrical body after extending from one end of the movable element facing the massage element, and an end portion of the connection rod is rotatably connected to an outer side of the movable element.

3. The rotary telescopic massager according to claim 2, wherein a guide sleeve is disposed on an outer wall of the movable element, the guide rod is fixed on an inner wall of the first installation bracket or the first cylindrical housing, and the guide sleeve is sleeved over the guide rod.

4. The rotary telescopic massager according to claim 3, wherein a first fixation hole is formed in the first installation bracket, a first fixation sleeve is sleeved and fixed over one end of the guide rod, the first fixation sleeve is inserted into the first fixation hole, and the first fixation hole and the first fixation sleeve are fixed in an interference fit manner.

5. The rotary telescopic massager according to claim 2, wherein a first connection sleeve is fixed on the rotary output shaft, a second connection sleeve is disposed on the closed end of the cylindrical body, the first connection sleeve and the second connection sleeve are sleeved and fitted onto each other, and the first connection sleeve is connected to the second connection sleeve by a snap fastener.

6. The rotary telescopic massager according to claim 3, wherein the rotary telescopic apparatus further comprises a second installation bracket, wherein the second installation bracket is fixedly connected to the inner wall of the first cylindrical housing, the first motor is fixed on the second installation bracket, a second fixation hole is formed in the second installation bracket, a second fixation sleeve is sleeved and fixed over the other end of the guide rod, the second fixation sleeve is inserted into the second fixation hole, and the second fixation hole and the second fixation sleeve are fixed in an interference fit manner.

7. The rotary telescopic massager according to claim 1, wherein a connection shaft is fixed on the rotary output shaft, a first connector is fixed on the connection shaft, a support element is disposed between the first connector and a port of the guide channel, the connection shaft passes through a through hole of the support element, the support element is fixedly arranged in a radial direction, two first conductors are disposed on a first side on the first connector facing the support element, two second conductors are disposed on a third side on the support element facing the first connector, and each of the first conductors is in conductive contact with the two second conductors, respectively; the two first conductors are annular conductors arranged around the connection shaft, and the two second conductors are conductive pins or conductive springs; alternatively, the two first conductors are conductive pins or conductive springs, and the two second conductors are annular conductors arranged around the connection shaft; and
a second connector is disposed on the closed end of the cylindrical body, the first connector is connected to the second connector by a snap fastener, two third conductors are disposed on a second side on the first connector facing the second connector, two fourth conductors are disposed on a fourth side on the second connector facing the first connector, and each of the third conductors is in conductive contact with the two fourth conductors, respectively; the two third conductors are annular conductors arranged around the connection shaft, and the two fourth conductors are conductive pins or conductive springs; alternatively, the two third conductors are conductive pins or conductive springs, and the two fourth conductors are annular conductors arranged around the connection shaft,
wherein each of the first conductors is conductively connected to the two third conductors, respectively, a functional massage element is installed on the flexible massage sleeve, the two fourth conductors are conductively connected to the functional massage element via conductive connection wires after passing through the closed end of the cylindrical body, and the functional massage element is a first vibrator or an electric heating sheet.

8. The rotary telescopic massager according to claim 7, wherein the first connector comprises a first connection sleeve and a first annular plate, wherein the first annular plate is fixed within the first connection sleeve, the first side and the second side are disposed on the first annular plate, the two first conductors are disposed on the first side on the first annular plate facing the support element, and the two third conductors are disposed on the second side on the first connection sleeve facing the massage element;
the second connector comprises a second connection sleeve and a second annular plate, wherein the first connection sleeve and the second connection sleeve are sleeved and fitted onto each other, the first connection sleeve is connected to the second connection sleeve by a snap fastener, the fourth side is disposed on the second annular plate, the second annular plate is fixed within the second connection sleeve, and the two fourth conductors are disposed on the fourth side on the second annular plate facing the first connector; and
the support element comprises an annular support plate and a third annular plate, wherein the third side is disposed on the third annular plate, the third annular plate is fixed on the fifth side on the annular support plate facing the second annular plate, and the two second conductors are disposed on the third side on the third annular plate facing the second annular plate,
wherein the first connection sleeve, the first annular plate, the second connection sleeve, the second annular plate, the annular support plate and the third annular plate are coaxially arranged, and the connection shaft is fixedly connected to the first connection sleeve after passing through the annular support plate and the third annular plate in sequence; at least one guide rod is disposed on the annular support plate and inserted into a guide hole of the installation bracket to fix the support element in a radial direction; and a power supply apparatus is installed within the first cylindrical housing and conductively connected to the two second conductors via conductive connection wires.

9. The rotary telescopic massager according to claim 1, wherein a flexible sleeve is installed at an opening of the second cylindrical housing, a passageway is formed on the flexible sleeve and coaxially arranged with a massage chamber of the flexible massage sleeve, and a plurality of flexible massage protrusions are formed on an inner wall of the massage chamber of the flexible massage sleeve.

10. The rotary telescopic massager according to claim 8, wherein a second vibrator is embedded and installed in the flexible sleeve, the second vibrator is close to an inner wall of the passageway, and the power supply apparatus is installed within the first cylindrical housing and conductively connected to the second vibrator via a conductive connection wire after passing through the installation bracket.

11. The rotary telescopic massager according to claim 1, wherein a connection cylinder is formed on the first installation bracket, the first cylindrical housing is sleeved on a first half portion of the connection cylinder, the second cylindrical housing is sealed and sleeved over a second half portion of the connection cylinder by a seal ring, a plurality of L-shaped slots and a plurality of tabs are respectively disposed on an outer wall of the connection cylinder and an inner wall of a port of the second cylindrical housing facing the connection cylinder, and the tabs are engaged in horizontal slots of the L-shaped slots through longitudinal slots of the L-shaped slots.

12. The rotary telescopic massager according to claim 11, wherein a suction pump and an electromagnetic valve are disposed within the first cylindrical housing, the inner chamber of the connection cylinder and the inner chamber of the second cylindrical housing are joined to form a negative pressure massage chamber, a pressure relief port and a suction port are provided in a divider plate of the first installation bracket, an intake port of the second suction pump is connected to the suction port through a pipeline, an inlet port of the electromagnetic valve is coupled to the pressure relief port through a pipeline, and an outlet port of the electromagnetic valve and an exhaust port of the second suction pump are respectively coupled to two outlet holes on the first cylindrical housing through pipelines.
